(19) United States
(12) Patent Application Publication
(10) Pub. No.: US 2025/0037144 A1
(43) Pub. Date: Jan. 30, 2025

(54) Recommending Configurable Controls to an Entity

(71) Applicant: Google LLC, Mountain View, CA (US)

(72) Inventors: Aayush Srivastava, New York, NY (US); Zeal Prakash Somani, Brambleton, VA (US); Zeferino Delgadillo, III, Washington, DC (US); Alison Marlene Andrews, Stonington, CT (US)

(21) Appl. No.: 18/551,340

(22) PCT Filed: Jul. 25, 2023
(86) PCT No.: PCT/US2023/028557

§ 371 Date: Sep. 19, 2023

Related U.S. Application Data
(60) Provisional application No. 63/429,714, filed on Dec. 2, 2022.

(51) Int. Cl. G06Q 30/018

(52) U.S. Cl. CPC G06Q 30/018

(57) ABSTRACT

A computer-implemented method includes receiving, by one or more computing devices of an information management system, policy information relating to an entity, the policy information including information associated with a plurality of controls for implementing policies of the entity. The method further includes extracting, via a machine learning resource associated with the one or more computing devices, the plurality of controls from the policy information, recommending, via the machine learning resource, a first plurality of controls from the plurality of controls configurable by the entity and a second plurality of controls from the plurality of controls configurable by a service provider. The method further includes applying, by the one or more computing devices, one or more of the first plurality of controls and one or more of the second plurality of controls, to implement the policies of the entity.

### PRIORITY CLAIM

This application is based on and claims priority to U.S. Provisional Application 63/429,714 having a filing date of Dec. 2, 2022, which is incorporated by reference herein in its entirety for all purposes.

### FIELD

The disclosure generally relates to an information management system which recommends controls for implementing policies of an entity. More particularly, the disclosure relates to a machine learning resource which recommends controls configured by the entity for implementing policies of the entity and controls configured by a service provider for implementing policies of the entity.

### BACKGROUND

Information management systems may be used to manage governance, risk, and compliance (GRC) policies of an entity (e.g., an organization). Various controls may be implemented to monitor information, processes, or compliance with regulations and policies that are relevant to the entity. Controls may be mapped to various standards including ISO/IE 27001 standards (covering privacy, cybersecurity, technical security issues, etc. to manage information security), Health Insurance Portability and Accountability Act standards (covering healthcare information for billing and handling of protected health information), and Sarbanes-Oxley standards (covering corporate disclosure accuracy and reliability requirements), and the like.

### SUMMARY

Aspects and advantages of embodiments of the disclosure will be set forth in part in the following description, or can be learned from the description, or can be learned through practice of the embodiments.

One example aspect of the disclosure is directed to a computer-implemented method which includes receiving, by one or more computing devices of an information management system, policy information relating to an entity, the policy information including information associated with a plurality of controls for implementing policies of the entity. The method further includes extracting, via a machine learning resource associated with the one or more computing devices, the plurality of controls from the policy information, recommending, via the machine learning resource, a first plurality of controls from the plurality of controls configurable by the entity and a second plurality of controls from the plurality of controls configurable by a service provider. The method further includes applying, by the one or more computing devices, one or more of the first plurality of controls and one or more of the second plurality of controls, to implement the policies of the entity.

Another example aspect of the disclosure is directed to a computing system (e.g., a server computing system) which includes one or more processors and one or more non-transitory computer-readable media that store instructions that, when executed by the one or more processors, cause the computing system to perform operations. For example, the operations may include receiving policy information relating to an entity, the policy information including information associated with a plurality of controls for implementing policies of the entity, extracting, via a machine learning resource, the plurality of controls from the policy information, recommending, via the machine learning resource, a first plurality of controls from the plurality of controls configurable by the entity and a second plurality of controls from the plurality of controls configurable by a service provider associated with the server computing system, and applying one or more of the first plurality of controls and one or more of the second plurality of controls, to implement the policies of the entity.

Another example aspect of the disclosure is directed to a computer-implemented method which includes receiving, by one or more computing devices of an information management system, policy information relating to an entity, extracting, via a machine learning resource associated with the one or more computing devices, keywords from the policy information, mapping, via the machine learning resource, the keywords extracted from the policy information with controls stored in a controls database to determine a plurality of controls for implementing policies of the entity, recommending, via the machine learning resource, a first plurality of controls from the plurality of controls configurable by the entity and a second plurality of controls from the plurality of controls configurable by a service provider; and applying, by the one or more computing devices, one or more of the first plurality of controls and one or more of the second plurality of controls, to implement the policies of the entity.

In one or more example embodiments, a computer-readable medium (e.g., a non-transitory computer-readable medium) which stores instructions that are executable by one or more processors of a computing device is provided. In some implementations the computer-readable medium stores instructions which may include instructions to cause the one or more processors to perform one or more operations of any of the methods described herein (e.g., operations of the entity computing device, the third party computing device, and the server computing system). The computer-readable medium may store additional instructions to execute other aspects of the entity computing device, the third party computing device, and the server computing system and corresponding methods of operation, as described herein.

These and other features, aspects, and advantages of various embodiments of the disclosure will become better understood with reference to the following description and appended claims. The accompanying drawings, which are incorporated in and constitute a part of this disclosure, illustrate example embodiments and, together with the description, serve to explain the related principles.

### BRIEF DESCRIPTION OF THE DRAWINGS

Detailed discussion of embodiments directed to one of ordinary skill in the art is set forth in the specification, which makes reference to the appended drawings, in which:

FIG. 1 depicts a block diagram of an example process performed by an information management system of a server computing system in response to receiving policy information from an entity, according to one or more example embodiments of the disclosure;

FIG. 2 depicts a block diagram of an example process performed by the machine learning resource in response to receiving policy information from an entity, according to one or more example embodiments of the disclosure;

FIG. 3 depicts an example user interface screen for providing information about an entity to identify relevant compliance regulations, standards, and controls for implementing policies of the entity, according to one or more example embodiments of the disclosure;

FIG. 4 depicts an example user interface screen for providing a recommendation to an entity concerning relevant compliance regulations, standards, and controls for implementing policies of the entity, according to one or more example embodiments of the disclosure; and

FIG. 5 depicts an example system, according to one or more example embodiments of the disclosure;

### DETAILED DESCRIPTION

Reference now will be made to embodiments of the disclosure, one or more examples of which are illustrated in the drawings, wherein like reference characters across drawings are intended to denote like features in various implementations. Each example is provided by way of explanation of the disclosure and is not intended to limit the disclosure.

Generally, the disclosure is directed to an information management system which recommends and assigns controls for implementing policies of an entity. More particularly, the disclosure relates to a machine learning resource which recommends and assigns controls that are configurable by the entity (e.g., an organization) for implementing policies of the entity and controls that are configurable by a service provider (e.g., a cloud-provider) for implementing policies of the entity.

For example, an entity may include an organization (e.g., a company, a business, an institution, an association, etc.).

For example, a service provider may include a cloud service provider which is an organization that offers cloud computing services including one or more of a cloud-based platform (i.e., platform as a service-PaaS), infrastructure (i.e., infrastructure as a service-IaaS), application (i.e., software as a service-SaaS), and storage services.

For example, an information management system may refer to a computer system or computing services which are used to track or monitor information relating to an entity, to store information relating to the entity, and to implement or manage functions relating to the entity. For example, the information management system may be configured to track or monitor policy information relating to an entity. The policy information may include compliance information, security information, and the like. For example, the information management system may be configured to store policy information relating to the entity, to store controls relating to the entity, and to store a mapping of the controls to one or more standards which are used to satisfy or implement the policies of the entity. In some implementations, the information management system may be implemented by a computer system which is remotely provided (i.e., a server computing system of a service provider).

For example, controls may refer to technical, administrative, or physical processes used to manage risks through preventing, detecting, or reducing the impact of threats and to reasonably ensure that the entity is complying with all applicable laws, rules and regulations, as well as internal codes of conduct, policies, and procedures. For example, controls may be mapped to standards that are implemented to satisfy various requirements (e.g., statutory requirements, regulatory requirements, internal requirements, etc.). Example standards include ISO/IE 27001 standards (covering privacy, cybersecurity, technical security issues, etc. to manage information security), Health Insurance Portability and Accountability Act standards (covering healthcare information for billing and handling of protected health information), and Sarbanes-Oxley standards (covering corporate disclosure accuracy and reliability requirements), and the like.

Current methods for managing governance, risk, and compliance (GRC) policies of an entity involve members of service providers (e.g., cloud vendors) interacting with procurement teams of an entity to manually map controls to be associated with the service provider and controls to be associated with the entity. Such a process can be extremely cumbersome and take several weeks to perform.

According to various example embodiments disclosed herein, a server computing system (e.g., associated with a service provider) is configured to receive policy information relating to an entity. The policy information may include a plurality of controls for implementing policies of the entity via an information management system associated with the service provider. For example, the entity may provide the policy information to the server computing system by transmitting the policy information from an entity computing device associated with the entity to the server computing system. In some implementations, the policy information may be obtained by the entity computing device when a user scans or uploads a document which includes controls for implementing policies of the entity. The document may be in the form of a PDF file, a CSV file, a DOC file and the like. The document may then be transmitted to the server computing system. In some implementations, the policy information may be obtained by other methods including via a voice input from a user providing policy information, where the voice input can be converted to text via speech recognition computing methods. The converted text information may then be transmitted to the server computing system or in some implementations the server computing system may perform the speech conversion to obtain the policy information.

In some implementations, in response to the server computing system receiving the policy information, the server computing system is configured to extract controls from the policy information. For example, the extraction of the controls from the policy information may be implemented using a machine learning resource which parses the policy information (e.g., by analyzing the text for keywords that correspond to controls and/or control specifications). In some implementations, the machine learning resource may be implemented using a heuristic-based keyword matching algorithm. For example, a term frequency-inverse document frequency (TF-IDF) method may be implemented by the machine learning resource to measure the relevance of words in the policy information (e.g., based positively on how many times a word appears in a document and based inversely on how often the word appears in other documents). In some implementations, the TF-IDF method may be implemented in combination with a K nearest neighbor (KNN) method to classify words from the document (e.g., to a particular control domain such as encryption, threat management, compliance, etc.) and/or to map words (corresponding to controls) from the policy information to words (corresponding to controls) in a controls database of the server computing system. In some implementations, machine learning resource methods other than those mentioned above may be implemented to identify controls from the policy information and to map the identified controls to various standards for implementing the policies of the entity. For example, in some implementations the machine learning resource may include a large language model that is trained using various sets of training data (e.g., using a collection of documents having thousands of different controls for various industry segments) such that when a document including controls is provided the machine learning resource is configured to output controls which are configurable by the entity (e.g., via a portal) and controls which are configurable by a service provider (e.g., via the information management system of the server computing system).

In some implementations, the machine learning resource may be configured to classify the controls according to a responsibility as to whether the controls are to be implemented or managed by the entity, by the service provider, by a third party, or in a shared manner by a combination of two or more of the entity, the service provider, and the third party. For example, controls which are managed or configured by the service provider may include infrastructure-related controls. For example, controls which are managed or configured by the entity may include technical controls and operational controls (e.g., controls for asset management, asset inventory, centrally managing permission, enforcing and managing privileges, etc.). In some implementations, the server computing system may be configured to recommend products or services that the entity may need to satisfy its obligations for implementing the controls that the entity is responsible for. In some implementations, a third party may be authorized by the entity and/or the service provider to manage or configure controls to implement policies of the entity. The machine learning resource may be configured to recommend the controls to the entity which are to be implemented or managed by the entity, by the service provider, by the third party, or in a shared manner by a combination of two or more of the entity, the service provider, and the third party, based on the classification. The controls may be automatically assigned (for example, in a default manner) according to the recommendation of the machine learning resource. In some implementations, the entity may deviate from the recommendation and alter the recommendation of controls provided by the machine learning resource.

In some implementations, the server computing system may be configured to apply the controls which are recommended by the machine learning resource in order to implement the policies of the entity.

As an example, the machine learning resource may perform a parsing operation on a document provided by an entity and extract one or more controls related to network security. The one or more controls which are extracted may correspond to controls provided in a controls database associated with the server computing system. The machine learning resource may map the one or more controls to various standards and/or safeguards used to satisfy the policies of the entity (e.g., Center for Internet Security (CIS) critical security controls safeguards, Payment Card Industry Data Security Standards (PCI DSS), Association of International Certified Professional Accountants (AICPA) Trust Services Criteria standards, National Institute of Standards (NIST) framework requirements, International Organization for Standardization/International Electrotechnical Commission (ISO/IEC) standards, cloud controls matrix (CCM) framework requirements, etc.). For example, network security controls may map to particular controls of NIST 800-53 including control identifiers SC-4, SC-11, SC-12, etc. that define various standards including trusted path requirements, cryptographic key establishment and management requirements, etc. In addition, the machine learning resource may associate one or more controls with the entity, one or more controls with the service provider, or one or more controls as being a shared responsibility between the entity and the service provider. For example, infrastructure related network security controls may be classified as service provider controls. The information management system of the server computing system may be configured to apply the network security controls to implement policies of the entity, for example, by providing purpose-built chips, purpose-built servers, purpose built-networks, purpose-built data centers, cryptographic credentials, etc., for ensuring that the entity complies with various network security compliance requirements and prevents or reduces security risks.

The disclosure provides numerous technical effects and benefits. For example, the extraction of controls and mapping of the controls to service provider controls and entity controls via a machine learning resource greatly reduces the time currently required to perform such processes (e.g., from a few weeks to less than a few minutes). For example, the extraction of controls and mapping of the controls to service provider controls and entity controls via the machine learning resource may increase an accuracy and detection of controls which may be missed according to current methods due to the laboriousness nature involved in identifying controls manually. For example, the combination of KNN and TF-IDF methods to identify controls may improve an accuracy of detection of controls compared to current methods. The disclosed method for implementing policies of an entity via a service provider over a network improves the technology of information management systems used to implement such policies by the use of the machine learning resource to extract, identify, recommend, and assign controls for implementing the policies of the entity.

With reference now to the drawings, example embodiments of the disclosure will be discussed in further detail.

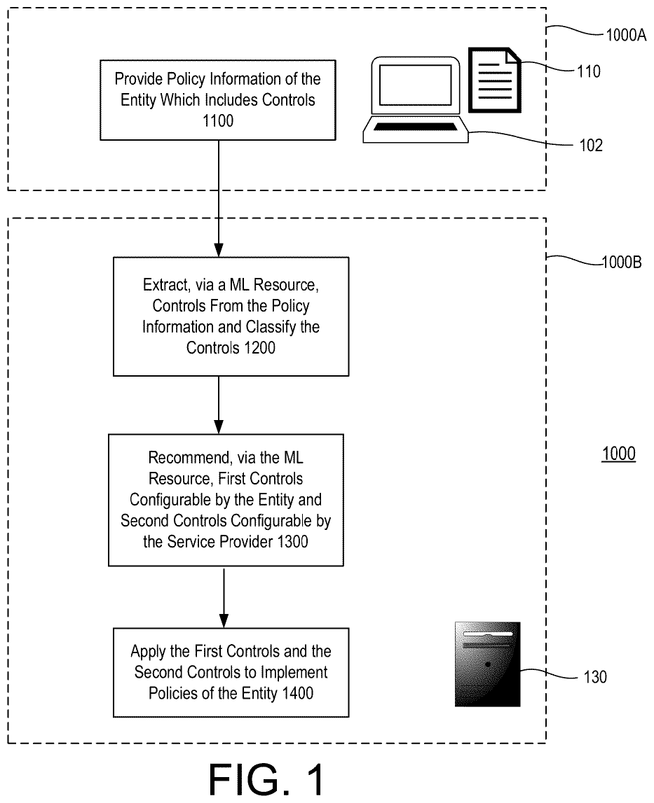

FIG. 1 depicts a block diagram of an example process performed by an information management system of a server computing system in response to receiving policy information from an entity.

The entity computing device 102 can be any type of computing device, such as, for example, a personal computing device (e.g., laptop or desktop), a mobile computing device (e.g., smartphone or tablet), a gaming console or controller, a wearable computing device (e.g., a virtual/augmented reality device, etc.), an embedded computing device, a broadcasting computing device (e.g., a webcam, etc.), or any other type of computing device. For example, the entity computing device 102 may receive or obtain policy information 110 relating to policies of the entity 1000A. For example, the policy information 110 may be received in the form of a document or collection of documents. The documents may include information relating to policies and/or compliance requirements of the entity, including RFPs (requests for proposals), RFQs (requests for quotations), RFIs (requests for information), etc. The entity computing device 102 may be configured to obtain the policy information 110 through various methods (e.g., by scanning the document, by receiving the document in an electronic form including by e-mail, by transferring the file electronically, etc.) In some implementations, the policy information 110 may be in the form of a PDF file, a CSV file, a DOC file and the like. The document may then be transmitted to the server computing system.

The entity computing device 102 may also be configured to obtain the policy information 110 via a voice input of a user, for example. The voice input can be converted to text via known speech recognition computing methods. The converted text information may then be transmitted to the server computing system 130 or in some implementations the server computing system 130 may perform the speech conversion to obtain the policy information 110 in text form.

At operation 1100 of process 1000 the entity computing device 102 may be configured to transmit the policy information associated with the entity 1000A to the server computing system 130 which is associated with the service provider 1000B and which is used to implement the information management system of the service provider 1000B.

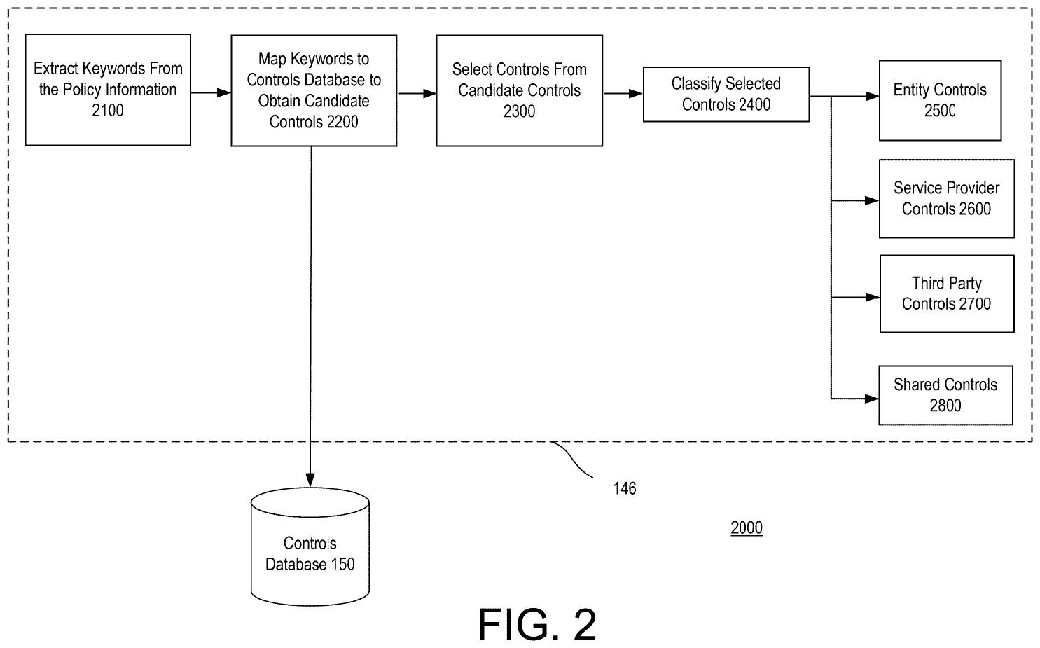

At operation 1200, in response to the server computing system 130 receiving the policy information 110, the server computing system 130 may be configured to extract controls from the policy information 110 via a machine learning resource 146 (see FIG. 2). For example, the extraction of the controls from the policy information 110 may be implemented using the machine learning resource 146 which parses the policy information 110 (e.g., by analyzing the text for keywords that correspond to controls and/or control specifications). In some implementations, the machine learning resource 146 may be implemented using a heuristic-based keyword matching algorithm. For example, a term frequency-inverse document frequency (TF-IDF) method may be implemented by the machine learning resource 146 to measure the relevance of words in the policy information (e.g., based positively on how many times a word appears in a document and based inversely on how often the word appears in other documents). In some implementations, the TF-IDF method may be implemented in combination with a K nearest neighbor (KNN) method or another cluster analysis technique (e.g., centroid-based clustering, distribution-based clustering, etc.) to classify words from the document (e.g., to a particular control domain such as encryption, threat management, compliance, network security, etc.) and/or to map words (corresponding to controls) from the policy information 110 to words (corresponding to controls) in a controls database 150 associated with the server computing system 130. The controls database 150 may be integrally provided with the server computing system 130 (e.g., as part of the one or more memory devices 134 of the server computing system 130) or may be separately (e.g., remotely) provided.

In some implementations, machine learning methods implemented by the machine learning resource 146 other than the TF-IDF method and KNN method may be implemented to identify controls from the policy information 110 and to map the identified controls to various standards for implementing the policies of the entity 1000A. For example, in some implementations the machine learning resource 146 may include a large language model that is trained using various sets of training data (e.g., using a collection of documents having thousands of different controls for various industry segments) such that when a document including controls is provided the machine learning resource 146 is configured to output controls which are configurable by the entity 1000A (e.g., via a portal) and controls which are configurable by a service provider 1000B (e.g., via the security and compliance information management system 142 of the server computing system 130).

At operation 1200, in response to extracting the controls from the policy information 110 via the machine learning resource 146, the machine learning resource 146 may be configured to classify the controls according to a responsibility as to whether the controls are to be implemented or managed by the entity 1000A, by the service provider 1000B, by a third party (e.g., via a third party computing device 160), or in a shared manner by a combination of two or more of the entity 1000A, the service provider 1000B, and the third party. For example, controls which are managed or configured by the service provider 1000B may include infrastructure-related controls. For example, controls which are managed or configured by the entity 1000A may include technical controls and operational controls (e.g., controls for asset management, asset inventory, centrally managing permission, enforcing and managing privileges, etc.). In some implementations, the server computing system 130 may be configured to recommend products or services that the entity 1000A may need to satisfy its obligations for implementing the controls that the entity 1000A is responsible for. In some implementations, the third party may be authorized by the entity 1000A and/or the service provider 1000B to manage or configure controls to implement policies of the entity 1000A.

At operation 1300, the machine learning resource 146 may be configured to recommend the controls to the entity 1000A which are to be implemented or managed by the entity 1000A, by the service provider 1000B, by the third party, or in a shared manner by a combination of two or more of the entity 1000A, the service provider 1000B, and the third party, based on the classification. For example, the server computing system 130 may be configured to provide, for presentation on a display of the entity computing device 102, a user interface screen which indicates second controls which the entity 1000A inherits from the service provider 1000B (i.e., controls that are the responsibility of the service provider 1000B), and first controls which the entity 1000A is responsible for. In some implementations, one or more controls may be assigned to, and be the responsibility of, the third party. In some implementations, one or more controls may be assigned to, and be the responsibility of, two or more of the entity 1000A, the service provider 1000B, and the third party (i.e., shared controls). The controls may be automatically assigned (for example, in a default manner) according to the recommendation of the machine learning resource 146. In some implementations, the entity 1000A may deviate from the recommendation and alter the recommendation of controls provided by the machine learning resource 146. For example, the entity 1000A may provide an input via an input device 124 to change a setting or control assignment via the user interface screen which may be presented through the service provider portal and application 121. Controls which are managed by the entity 1000A may be configured, for example, via the entity computing device 102 and service provider portal and application 121. Controls which are managed by the service provider 1000B may be configured via the server computing system 130 and service provider portal and application 144. Likewise, controls which are managed by the third party may be configured by via the third party computing device 160 via a service provider portal and application similar to service provider portal and application 121.

At operation 1400, the server computing system 130 may be configured to apply the controls which are recommended by the machine learning resource 146 in order to implement the policies of the entity 1000A. For example, the security and compliance information management system 142 may be configured to apply controls to implement policies of the entity 1000A, for example, by configuring computing systems to satisfy the requirements set forth in standards corresponding to controls which are extracted from the policy information 110. For example, the security and compliance information management system 142 may be configured to utilize a particular encryption standard (e.g., Advanced Encryption Standard (AES) 128, AES-256, etc.) to meet the requirements of a particular control.

FIG. 2 depicts a block diagram of an example process performed by the machine learning resource in response to receiving policy information from an entity. For example, at operation 2100 of process 2000 the machine learning resource 146 extracts keywords from the policy information 110. For example, the keywords may correspond to words which are used frequently (a frequency greater than a first threshold frequency level) in a particular document (e.g., a document concerning policies of the entity 1000A), but are not used frequently (less than a second threshold frequency level) in other documents (which may or may not pertain to policies of the entity 1000A). For example, a term frequency-inverse document frequency (TF-IDF) method may be implemented by the machine learning resource 146 to measure the relevance of words in the policy information (e.g., increasing a weight given to a word the more often the word appears in a document and decreasing a weight given to the word the more often the word appears in other documents). In some implementations, the TF-IDF method may be implemented in combination with a K nearest neighbor (KNN) method or another cluster analysis technique (e.g., centroid-based clustering, distribution-based clustering, etc.) to classify words from the document (e.g., to a particular control domain such as encryption, threat management, compliance, network security, etc.). For example, when the machine learning resource 146 parses the word “encryption” from the document, the word may be associated with the control domain of cryptography, encryption, and key management.

For example, at operation 2200 the machine learning resource 146 maps the extracted keywords from the policy information 110 to a controls database 150 to obtain candidate controls. For example, the machine learning resource 146 may be configured to map the keywords (e.g., corresponding to controls) from the policy information 110 to words (e.g., corresponding to controls) in the controls database 150 associated with the server computing system 130. The controls database 150 may be integrally provided with the server computing system 130 (e.g., as part of the one or more memory devices 134 of the server computing system 130) or may be separately (e.g., remotely) provided. For example, the machine learning resource 146 may be configured to implement a KNN method to identify controls from the controls database 150 which are most similar to extracted keywords from the policy information 110 as candidate controls.

At operation 2300, the machine learning resource 146 may be configured to select all of the candidate controls or a subset of the candidate controls for implementing the policies of the entity 1000A. For example, the machine learning resource 146 may be configured to select a predetermined number of controls from among the candidate controls. The predetermined number may be determined by training the machine learning resource 146 via supervised learning (e.g., based on a human agent identifying the most relevant controls and ignoring the remaining suggested controls). The number of controls selected from the candidate controls may be determined based on a relevance score of each of the identified candidate controls where controls which have a relevance score less than a threshold relevance level are not selected, or the predetermined number may be determined as a maximum number of controls. The relevance of a control may correspond to a likelihood that the control is relevant or needed for ensuring the entity 1000A complies with the requirements outlined in the policy information 110. As another example, the machine learning resource 146 may be configured to select the subset of the candidate controls for implementing the policies of the entity 1000A based on a similarity of the candidate controls with the controls extracted from the policy information 110. Those candidate controls determined by the machine learning resource 146 as the most similar (e.g., a similarity greater than a threshold similarity level) may be selected by the machine learning resource 146. For example, the machine learning resource 146 may implement a similarity method to quantify a similarity between the candidate controls and the controls extracted from the policy information. For example, the machine learning resource 146 may implement a cosine similarity method to measure a similarity between the candidate controls and the controls extracted from the policy information. A higher degree of similarity between keywords (corresponding to controls) extracted from the policy information 110 and a control stored in the controls database 150 indicates the control stored in the controls database 150 is more likely to be relevant to implementing the policies of the entity 1000A.

As an example, if ten candidate controls are obtained by mapping the extracted keywords from the policy information 110 to a controls database 150, the machine learning resource 146 may determine a similarity between each of the candidate controls and the keywords (corresponding to controls) extracted from the policy information 110. If a similarity between each of the candidate controls and the keywords (corresponding to controls) extracted from the policy information 110 is greater than a similarity threshold level for six of the candidate controls and less than the similarity threshold level for four of the candidate controls, the machine learning resource 146 may select the six candidate controls for implementing the policies of the entity 1000A.

At operation 2400, the machine learning resource 146 is configured to classify the selected controls according to a responsibility as to whether the controls are to be implemented or managed by the entity 1000A, by the service provider 1000B, by a third party (e.g., via a third party computing device 160), or in a shared manner by a combination of two or more of the entity 1000A, the service provider 1000B, and the third party. For example, service provider controls 2600 are managed or configured by the service provider 1000B and may include infrastructure-related controls. For example, entity controls 2500 which are managed or configured by the entity 1000A may include technical controls and operational controls (e.g., controls for asset management, asset inventory, centrally managing permission, enforcing and managing privileges, etc.). In some implementations, the server computing system 130 may be configured to recommend products or services that the entity 1000A may need to satisfy its obligations for implementing the controls that the entity 1000A is responsible for. In some implementations, the third party may be authorized by the entity 1000A and/or the service provider 1000B to manage or configure third party controls 2700 to implement policies of the entity 1000A. In some implementations, shared controls 2800 correspond to controls which are managed or configured by a combination of two or more of the entity 1000A, the service provider 1000B, and the third party.

The machine learning resource 146 may further be configured to recommend and/or assign controls among the classified entity controls 2500, service provider controls 2600, third party controls 2700, and shared controls 2800 for implementing the policies of the entity 1000A. These controls can subsequently be applied by the security and compliance information management system 142 based on the configurations set by the entity 1000A for entity controls 2500, the configurations set by the service provider 1000B for service provider controls 2600, the configurations set by the third party for third party controls 2700, and the configurations set by one or more of the entity 1000A, the service provider 1000B, and the third party for the shared controls 2800.

Although the example of FIG. 2 has described the machine learning resource 146 utilizing the TF-IDF method and KNN method to identify controls from the policy information 110 and to map the identified controls to controls in the controls database 150 which have corresponding standards for implementing the policies of the entity 1000A, other methods may be implemented. For example, in some implementations the machine learning resource 146 may include a large language model (LLM) that is trained using various sets of training data (e.g., using a collection of documents having thousands of different controls for various industry segments) such that when a document including controls is provided the machine learning resource 146 is configured to output controls which are configurable by the entity 1000A (e.g., via a portal), controls which are configurable by a service provider 1000B (e.g., via the security and compliance information management system 142 of the server computing system 130), controls which are configurable by the third party, and controls which are configurable in a shared manner.

As mentioned above, the entity 1000A may initially provide the policy information 110 to the server computing system 130. For example, a user (e.g., an administrator of the entity 1000A) of the entity computing device 102 may utilize a security and compliance tool 120 including a service provider portal and application 121 to transmit the policy information 110 to the server computing system 130. For example, the service provider portal and application 121 may include a portal by which the user can upload the policy information 110 to the server computing system 130. For example, the portal may include a user interface screen (e.g., a graphical user interface (GUI)) through which the user can provide information about the entity 1000A which can be used to identify relevant controls (e.g., controls which are applicable to a particular industry, to a particular industry, to a particular segment, to a particular type of activity or workload, etc.).

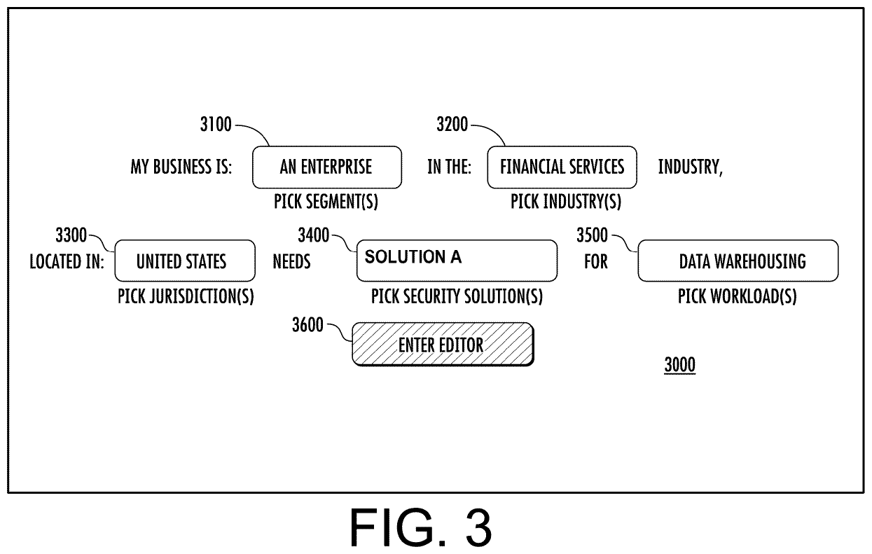

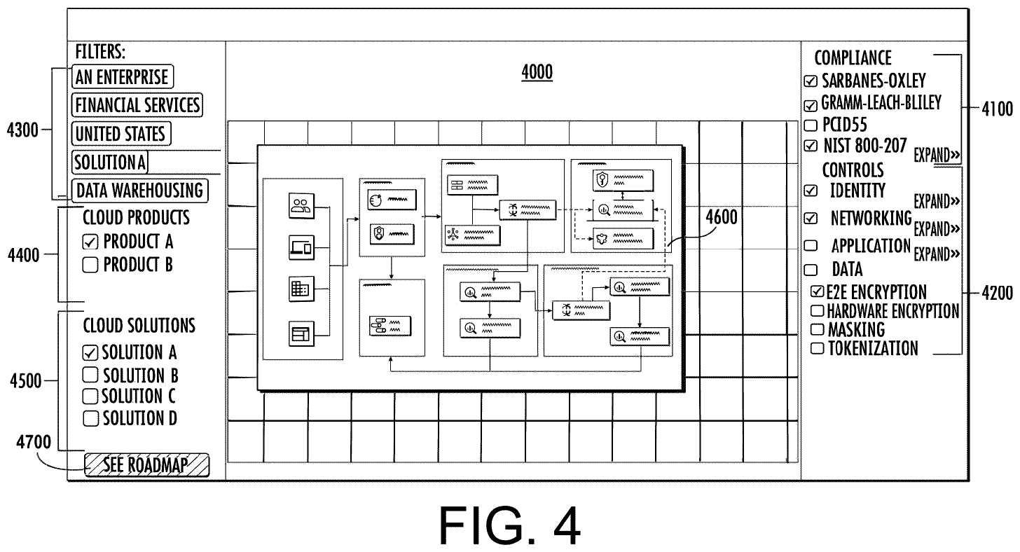

FIG. 3 depicts an example user interface screen for providing information about an entity to identify relevant compliance regulations, standards, and controls for implementing policies of the entity. For example, FIG. 3 illustrates user interface screen 3000 which may be provided for presentation on a display of the entity computing device 102 in response to executing the service provider portal and application 121. For example, as shown in FIG. 3 the user interface screen 3000 includes user interface elements 3100, 3200, 3300, 3400, and 3500 which serve as filters for identifying relevant compliance regulations, standards, and controls for implementing policies of the entity 1000A. For example, a segment of the entity 1000A may be identified or selected through user interface element 3100 (e.g., an “Enterprise” in FIG. 3). For example, an industry of the entity 1000A may be identified or selected through user interface element 3200 (e.g., “Financial Services” industry in FIG. 3). For example, jurisdictional information of the entity 1000A (e.g., a city, county, state, country, etc.) may be identified or selected through user interface element 3300 (e.g., the “United States” in FIG. 3). For example, a product, solution, or service requested by the entity 1000A which is offered by the service provider 1000B may be identified or selected through user interface element 3400 (e.g., “Solution A” in FIG. 3). For example, an activity or workload that is performed by the entity 1000A may be identified or selected through user interface element 3500 (e.g., “Data Warehousing” in FIG. 3). The information provided via the user interface screen 3000 by the entity 1000A may be used in combination with the provided policy information 110 to identify relevant compliance regulations and controls. For example, selection of user interface element 3600 after providing the relevant information via user interface elements 3100, 3200, 3300, 3400, and 3500 may cause an editor to be executed (e.g., as shown in FIG. 4 discussed below) which identifies the relevant compliance regulations or standards as well as controls.

FIG. 4 depicts an example user interface screen for providing a recommendation to an entity concerning relevant compliance regulations, standards, and controls for implementing policies of the entity. For example, illustrates user interface screen 4000 which may be provided for presentation on a display of the entity computing device 102 in response to executing the service provider portal and application 121 and/or in response to selection of user interface element 3600. For example, as shown in FIG. 4 the user interface screen 4000 includes user interface elements 4100, 4200, 4300, 4400, 4500, and 4600 which are included in an editor.

For example, the information provided via the user interface screen 3000 by the entity 1000A may be used in combination with the provided policy information 110 to identify relevant compliance regulations and controls which are indicated in the editor as shown by the user interface screen 4000. The server computing system 130, and particularly the machine learning resource 140 may be configured to provide the recommendations of the compliance regulations, standards, and controls in accordance with the examples of FIGS. 1 and 2 based on the policy information 110 received by the server computing system 130 from the entity computing device 102, and in combination with the filters indicated by user interface element 4300 which were indicated via user interface screen 3000. For example, in FIG. 4 applicable compliance regulations and standards are indicated by user interface element 4100 and include Sarbanes-Oxley, Gramm-Leach-Bliley, and NIST 800-207. For example, controls which are applicable to the identified compliance regulations and standards are indicated by user interface element 4200 and include identity controls, networking controls, E2E encryption.

The security and compliance information management system 142 may be further configured to recommend products and solutions offered by the service provider 1000B which can be used by the entity 1000A to manage and configure the entity controls which are the responsibility of the entity 1000A. For example, user interface element 4400 from user interface screen 4000 indicates service provider products (e.g., cloud products including Product A and Product B) which can be used by the entity 1000A to manage and configure the entity controls which are the responsibility of the entity 1000A. For example, FIG. 4 depicts that the security and compliance information management system 142 has recommended Product A. For example, reference numeral 4500 from user interface screen 4000 indicates service provider solutions (e.g., cloud solutions including Solution A, Solution B. Solution C, and Solution D) which can be used by the entity 1000A to manage and configure the entity controls which are the responsibility of the entity 1000A. For example, FIG. 4 depicts that the security and compliance information management system 142 has recommended Solution A.

For example, user interface screen 4000 may further include an architecture diagram 4600 which can show how controls are implemented for a particular workload and may further indicate which controls are the responsibility of the entity 1000A, which controls are the responsibility of the service provider 1000B, which controls are the responsibility of the third party, and which controls are shared.

For example, user interface screen 4000 may include a user interface element 4700 corresponding to a roadmap which, when selected, may present a user interface screen that indicates future capabilities for controls in connection with service provider products and service provider solutions. The user may be able to select such controls in advance for future deployment with a particular service provider product and/or service provider solution. For example, if the cloud solution Solution D is presently not compatible with end-to-end (E2E) encryption controls, but the roadmap indicates Solution D will be compatible with E2E encryption controls in the future, the user may be able to select end to end encryption controls in conjunction with Solution D as a configuration for a future deployment.

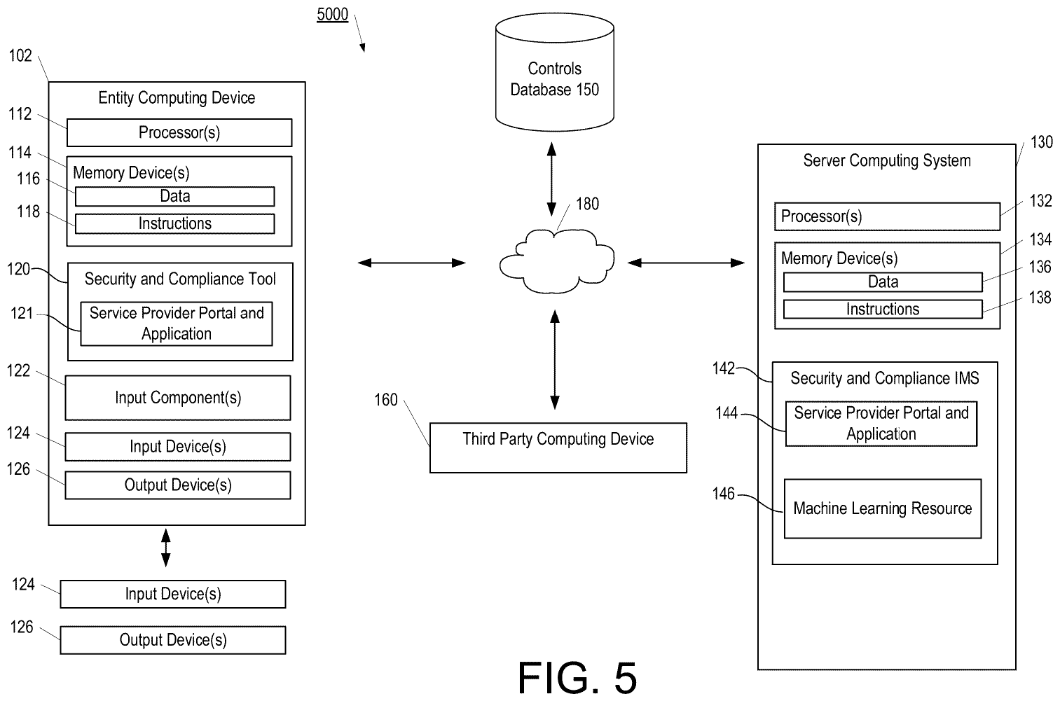

FIG. 5 depicts an example system, according to one or more example embodiments of the disclosure. For example, the example system 5000 includes the entity computing device 102, the server computing system 130, third party computing device 160, and controls database 150. Third party computing device 160 may include similar features as the entity computing device 102 and therefore a detailed description of the components of the third party computing device 160 will not be provided for the sake of brevity.

As illustrated in FIG. 5, entity computing device 102 includes one or more processors 112 and one or more memory devices 114. The one or more processors 112 can be any suitable processing device (e.g., a processor core, a microprocessor, an ASIC, an FPGA, a controller, a microcontroller, etc.) and can be one processor or a plurality of processors that are operatively connected (e.g., in parallel). The one or more memory devices 114 can include one or more non-transitory computer-readable storage media, such as RAM, ROM, EEPROM, EPROM, flash memory devices, magnetic disks, etc., and combinations thereof. The one or more memory devices 114 can store data 116 and instructions 118 which are executed by the one or more processors 112 to cause the entity computing device 102 to perform operations.

The entity computing device 102 includes a security and compliance tool 120 to implement the policies of the entity 1000A, for example, via service provider portal and application 121. Operations of the security and compliance tool 120 and service provider portal and application 121 have been described herein.

The entity computing device 102 can also include one or more input components 122 that receive a user input. For example, the one or more input components 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example input components 122 include a microphone, a traditional keyboard, or other devices by which a user can provide user input.

In some implementations, the entity computing device 102 can include, or can be communicatively coupled to, one or more input devices 124. For example, the one or more input devices 124 may include a camera device configured to capture images (e.g., for scanning a document which includes policy information). In some implementations, the one or more input devices 124 may include audio capture devices, such as microphones (e.g., for recording information concerning policies of an entity which are provided via a voice input). In some implementations, the one or more input devices 124 may include sensor devices configured to capture sensor data indicative of movements and/or locations of a user of the entity computing device 102 (e.g., accelerometer(s), Global Positioning Satellite (GPS) sensor(s), gyroscope(s), infrared sensor(s), head tracking sensor(s) such as magnetic capture system(s), an omni-directional treadmill device, sensor(s) configured to track eye movements of the user, etc.).

In some implementations, the entity computing device 102 can include, or be communicatively coupled to, one or more output devices 126. The one or more output devices 126 can be, or otherwise include, a device configured to output audio data, image data, video data, etc. For example, the one or more output devices 126 may include a display device (e.g., a television, projector, smartphone display device, etc.) and a corresponding audio output device (e.g., speakers, headphones, etc.). As another example, the one or more output devices 126 may include display devices for an augmented reality device or virtual reality device.

The server computing system 130 includes one or more processors 132 and one or more memory devices 134. The one or more processors 132 can be any suitable processing device (e.g., a processor core, a microprocessor, an ASIC, an FPGA, a controller, a microcontroller, etc.) and can be one processor or a plurality of processors that are operatively connected (e.g., in parallel). The one or more memory devices 134 can include one or more non-transitory computer-readable storage media, such as RAM, ROM, EEPROM, EPROM, flash memory devices, magnetic disks, etc., and combinations thereof. The one or more memory devices 134 can store data 136 and instructions 138 which are executed by the one or more processors 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

In some implementations, the server computing system 130 can receive data of various types from the entity computing device 102, the third party computing device 160, and the controls database 150 (e.g., via the network 180, etc.). For example, in some implementations, the entity computing device 102 can capture video data, audio data, multimedia data (e.g., video data and audio data, etc.), sensor data, etc. and transmit such data to the server computing system 130. The server computing system 130 may receive the data (e.g., via the network 180).

In some implementations, the server computing system 130 may receive data from the entity computing device 102, the third party computing device 160, and the controls database 150, according to various encryption scheme(s) (e.g., codec(s), lossy compression scheme(s), lossless compression scheme(s), etc.).

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the server computing system 130 may include a security and compliance information management system 142. The security and compliance information management system 142 may be configured to facilitate the identification of controls based on policy information received from the entity computing device 102, via the service provider portal and application 144 and the machine learning resource 146. The security and compliance information management system 142 may be configured to facilitate the mapping of controls extracted from the policy information received from the entity computing device 102 to controls which are stored in controls database 150, via the service provider portal and application 144 and the machine learning resource 146. The security and compliance information management system 142 may be configured to facilitate the classification of the controls so as to recommend controls which are to be managed and configured by the entity 1000A, the service provider 1000B, the third party, or combinations thereof, via the service provider portal and application 144 and the machine learning resource 146. The security and compliance information management system 142 may be configured to facilitate the application of the controls by the entity 1000A, the service provider 1000B, the third party, or combinations thereof, so as to implement the policies of the entity 1000A, via the service provider portal and application 144 and the machine learning resource 146.

The server computing system 130 and the entity computing device 102 can communicate with the third party computing device 160 via the network 180. The third party computing device 160 can be any type of computing device(s), such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.).

Terms used herein are used to describe the example embodiments and are not intended to limit and/or restrict the disclosure. The singular forms “a,” “an” and “the” are intended to include the plural forms as well, unless the context clearly indicates otherwise. In this disclosure, terms such as “including”, “having”, “comprising”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, the elements are not limited by these terms. Instead, these terms are used to distinguish one element from another element. For example, without departing from the scope of the disclosure, a first element may be termed as a second element, and a second element may be termed as a first element.

It will be understood that when an element is referred to as being “connected” to another element, the expression encompasses an example of a direct connection or direct coupling, as well as a connection or coupling with one or more other elements interposed therebetween.

The term “and/or” includes a combination of a plurality of related listed items or any item of the plurality of related listed items. For example, the scope of the expression or phrase “A and/or B” includes the item “A”, the item “B”, and the combination of items “A and B”.

In addition, the scope of the expression or phrase “at least one of A or B” is intended to include all of the following: (1) at least one of A. (2) at least one of B, and (3) at least one of A and at least one of B. Likewise, the scope of the expression or phrase “at least one of A, B, or C” is intended to include all of the following: (1) at least one of A, (2) at least one of B. (3) at least one of C. (4) at least one of A and at least one of B. (5) at least one of A and at least one of C. (6) at least one of B and at least one of C, and (7) at least one of A, at least one of B, and at least one of C.

Terms such as “module”, and “unit,” and the like may be used herein in association with various features of the disclosure. Such terms may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, including software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Aspects of the above-described example embodiments may be recorded in computer-readable media (e.g., non-transitory computer-readable media) including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, Blue-Ray disks, and DVDs; magneto-optical media such as optical discs; and other hardware devices that are specially configured to store and perform program instructions, such as semiconductor memory, read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the non-transitory computer-readable storage media may also be embodied in at least one application specific integrated circuit (ASIC) or Field Programmable Gate Array (FPGA).

The technology discussed herein may make reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the disclosed subject matter has been described in detail with respect to various example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the disclosed subject matter as would be readily apparent to one of ordinary skill in the art. For instance, features illustrated or described as part of one embodiment can be used with another embodiment to yield a still further embodiment. Thus, it is intended that the disclosure cover such alterations, variations, and equivalents.

What is claimed is:

1. A computer-implemented method, comprising:
receiving, by one or more computing devices of an information management system, policy information relating to an entity, the policy information including information associated with a plurality of controls for implementing policies of the entity;
extracting, via a machine learning resource associated with the one or more computing devices, the plurality of controls from the policy information;
recommending, via the machine learning resource, a first plurality of controls from the plurality of controls configurable by the entity and a second plurality of controls from the plurality of controls configurable by a service provider; and
applying, by the one or more computing devices, one or more of the first plurality of controls and one or more of the second plurality of controls, to implement the policies of the entity.

2. The computer-implemented method of claim 1, wherein extracting the plurality of controls from the policy information includes parsing the policy information.

3. The computer-implemented method of claim 1, wherein extracting the plurality of controls from the policy information includes classifying each of the plurality of controls.

4. The computer-implemented method of claim 3, wherein classifying each of the plurality of controls comprises classifying each of the plurality of controls into one or more of service provider controls which are configurable by the service provider, entity controls which are configurable by the entity, third party controls which are configurable by an authorized third party, or shared controls which are configurable by two or more of the service provider, the entity, or the authorized third party.

5. The computer-implemented method of claim 2, wherein extracting the plurality of controls from the policy information includes extracting keywords from the policy information via the machine learning resource.

6. The computer-implemented method of claim 5, wherein extracting the keywords from the policy information via the machine learning resource includes implementing a term frequency-inverse document frequency method to measure a relevance of words in the policy information.

7. The computer-implemented method of claim 6, wherein extracting the keywords from the policy information via the machine learning resource includes implementing a clustering method to classify words from the policy information.

8. The computer-implemented method of claim 5, further comprising:
mapping the keywords extracted from the policy information to controls stored in a controls database; and
obtaining candidate controls based on the mapping from the controls database.

9. The computer-implemented method of claim 8, further comprising selecting a subset of the candidate controls to obtain the plurality of controls, based on a relevance of each of the candidate controls.

10. The computer-implemented method of claim 9, further comprising classifying each of the plurality of controls into one or more of service provider controls which are configurable by the service provider, entity controls which are configurable by the entity, third party controls which are configurable by an authorized third party, or shared controls which are configurable by two or more of the service provider, the entity, or the authorized third party.

11. The computer-implemented method of claim 1, wherein applying, by the one or more computing devices, the one or more of the first plurality of controls and the one or more of the second plurality of controls, to implement the policies of the entity includes at least one of:
applying one or more of the first plurality of controls by segmenting a network associated with the entity, or
applying one or more of the second plurality of controls by configuring infrastructure elements of a computing system associated with implementing the policies of the entity.

12. The computer-implemented method of claim 1, wherein at least one of the first plurality of controls or the second plurality of controls recommended via the machine learning resource includes an operational control.

13. The computer-implemented method of claim 1, further comprising receiving, by the one or more computing devices, entity information relating to the entity, the entity information including at least one of jurisdiction information of the entity, a type of industry associated with the entity, a type of workload performed by the entity, a type of entity, a type of service requested by the entity, or a type of product requested by the entity.

14. The computer-implemented method of claim 13, wherein recommending, via the machine learning resource, the first plurality of controls from the plurality of controls configurable by the entity and the second plurality of controls from the plurality of controls configurable by the service provider, is based on the entity information relating to the entity.

15. A server computing system, comprising:
one or more processors; and
one or more non-transitory computer-readable media that store instructions that, when executed by the one or more processors, cause the server computing system to perform operations, the operations comprising:
receiving policy information relating to an entity, the policy information including information associated with a plurality of controls for implementing policies of the entity,
extracting, via a machine learning resource, the plurality of controls from the policy information,
recommending, via the machine learning resource, a first plurality of controls from the plurality of controls configurable by the entity and a second plurality of controls from the plurality of controls configurable by a service provider associated with the server computing system, and
applying one or more of the first plurality of controls and one or more of the second plurality of controls, to implement the policies of the entity.

16. The server computing system of claim 15, wherein extracting the plurality of controls from the policy information includes parsing the policy information and classifying each of the plurality of controls.

17. The server computing system of claim 16, wherein classifying each of the plurality of controls comprises classifying each of the plurality of controls into one or more of service provider controls which are configurable by the service provider, entity controls which are configurable by the entity, third party controls which are configurable by an authorized third party, or shared controls which are configurable by two or more of the service provider, the entity, or the authorized third party.

18. The server computing system of claim 15, wherein extracting the plurality of controls from the policy information includes extracting keywords from the policy information via the machine learning resource by implementing a term frequency-inverse document frequency method to measure a relevance of words in the policy information and implementing a clustering method to classify words from the policy information.

19. The server computing system of claim 18, wherein the operations further comprise:
mapping the keywords extracted from the policy information to controls stored in a controls database,
obtaining candidate controls based on the mapping from the controls database, and
selecting a subset of the candidate controls to obtain the plurality of controls, based on a relevance of each of the candidate controls.

20. The server computing system of claim 16, wherein the operations further comprise.
receiving entity information relating to the entity, the entity information including at least one of jurisdiction information of the entity, a type of industry associated with the entity, a type of workload performed by the entity, a type of entity, a type of service requested by the entity, or a type of product requested by the entity, and
recommending, via the machine learning resource, the first plurality of controls from the plurality of controls configurable by the entity and the second plurality of controls from the plurality of controls configurable by the service provider, is based on the entity information relating to the entity.

21. A computer-implemented method, comprising:
receiving, by one or more computing devices of an information management system, policy information relating to an entity;
extracting, via a machine learning resource associated with the one or more computing devices, keywords from the policy information;
mapping, via the machine learning resource, the keywords extracted from the policy information with controls stored in a controls database to determine a plurality of controls for implementing policies of the entity;
recommending, via the machine learning resource, a first plurality of controls from the plurality of controls configurable by the entity and a second plurality of controls from the plurality of controls configurable by a service provider; and
applying, by the one or more computing devices, one or more of the first plurality of controls and one or more of the second plurality of controls, to implement the policies of the entity.
